(19) United States
(12) Patent Application Publication
(10) Pub. No.: US 2011/0194693 A1
(43) Pub. Date: Aug. 11, 2011

(54) CRYPTOGRAPHIC PROCESSING APPARATUS AND METHOD

(75) Inventors: Tetsuya IZU, Kawasaki (JP); Masahiko Takenaka, Kawasaki (JP)

(73) Assignee: FUJITSU LIMITED, Kawasaki-shi (JP)

(21) Appl. No.: 13/009,645

(22) Filed: Jan. 19, 2011

(30) Foreign Application Priority Data
Jan. 22, 2010 (JP) 2010-12624

(51) Int. Cl. H04L 9/00

(52) U.S. Cl. 380/255

(57) ABSTRACT

A cryptographic processing apparatus that encrypts plaintext using a fixed-value common key that is shared with other cryptographic processing apparatus, includes an acquiring unit that acquires random information being used within the cryptographic processing apparatuses, an encrypting unit that encrypts encryption target data using key information and outputs encrypted data when the encryption target data and the key information is set, a transmitting unit that transmits, to the other cryptographic processing apparatus, the encrypted data; and a setting unit that sets the fixed-value common key as the key information and the random information as the encryption target data when the random information is acquired by the acquiring unit, and sets the encrypted data as the key information and at least one portion of the plaintext as the target data when the encrypted data is acquired.

### CROSS-REFERENCE TO RELATED APPLICATION

This application is based upon and claims the benefit of priority of the prior Japanese Patent Application No. 2010-12624, filed on Jan. 22, 2010, the entire contents of which are incorporated herein by reference.

### FIELD

The embodiments discussed herein are related to a cryptographic processing apparatus and processing method used when sending and receiving encrypted data.

### BACKGROUND

For some time, sending and receiving data among cryptographic processing apparatus has involved encrypted communication to ensure security, wherein an encryption technique such as common key block cipher is implemented. Ordinarily, the data to be encrypted (i.e., the plaintext) is longer than the block length defined as the unit of data transmission when conducting encrypted communication using common key block cipher. For this reason, the plaintext is first partitioned into units equal to the block length. The partitioned blocks thus obtained are then encrypted and decrypted individually.

FIG. 19 illustrates an encryption process using the electronic codebook (hereinafter abbreviated ECB) mode. FIG. 20 illustrates a decryption process using the ECB mode. In FIGS. 19 and 20, an example common key block cipher processing sequence in ECB mode is explained as one example of an encryption and decryption process using a common key.

For example, if it is assumed that the plaintext illustrated in FIG. 19 has a plaintext length of 512 bits, and that the block length for the common key block cipher is 128 bits, then the plaintext will be partitioned into four blocks (plaintext block 1, plaintext block 2, plaintext block 3, and plaintext block 4) as a result of the encryption process. Furthermore, in the encryption process, the plaintext block 1 will be encrypted to create the ciphertext block 1. Similarly, ciphertext blocks 2 to 4 are created from the plaintext blocks 2 to 4. The four ciphertext blocks are then transmitted as a single collection of ciphertext from the transmitting cryptographic processing apparatus.

Meanwhile, at the receiving cryptographic processing apparatus, four ciphertext blocks are decrypted from the single collection of ciphertext, as illustrated in FIG. 20. By subsequently decrypting each ciphertext block, the respective plaintext blocks are obtained, and then the plaintext is decrypted from the four plaintext blocks. As described above, there are known problems with the ECB mode, in that permutations of the plaintext blocks or ciphertext blocks are possible, and falsification of the plaintext is possible.

FIG. 21 illustrates an encryption process using the cipher block chaining (hereinafter abbreviated CBC) mode. FIG. 22 illustrates a decryption process using the CBC mode. In order to resolve problems with the ECB mode like those described above, the CBC mode has been proposed as an encryption and decryption technique that takes block order into account. An encryption and decryption processing sequence using the CBC mode will now be described using FIGS. 22 and 23.

If it is assumed that the plaintext illustrated in FIG. 21 has a plaintext length of 512 bits, and that the block length for the common key block cipher is 128 bits, then the plaintext will be partitioned into four plaintext blocks, similarly to the ECB mode. Furthermore, in the encryption process, a ciphertext block 1 is generated by using the plaintext block 1, and an initialization vector 2100. The initialization vector 2100 is random data (such as an arbitrary 128-bit string) that is prepared separately from the plaintext.

More specifically, in the encryption process, the exclusive disjunction (XOR) is computed on a bit-wise basis between the plaintext block 1 and the initialization vector. By encrypting the resulting data, the ciphertext block 1 is obtained. Next, the exclusive disjunction is computed on a bit-wise basis between the plaintext block 2 and the ciphertext block 1. By encrypting the resulting data, the ciphertext block 2 is obtained. The ciphertext blocks 3 and 4 are similarly generated, and these four ciphertext blocks are then transmitted as the ciphertext. In addition, along with the transmission of the ciphertext, the initialization vector is also transmitted to the cryptographic processing apparatus set as the destination.

At the receiver, four ciphertext blocks are decrypted from the ciphertext and the initialization vector, as illustrated in FIG. 22. Subsequently, the decryption process involves decrypting the ciphertext block 1, computing the exclusive disjunction on a bit-wise basis between the decryption data and the initialization vector, and obtaining the plaintext block 1. Additionally, at the receiving cryptographic processing apparatus, the ciphertext block 2 is decrypted, the exclusive disjunction is computed on a bit-wise basis between the ciphertext blocks 1 and 2, and the plaintext block 2 is obtained. The plaintext blocks 3 and 4 are similarly generated, and the plaintext is recovered. During the decryption process as explained in FIG. 22, the ciphertext blocks are decrypted in order starting with the ciphertext block 1 in order to obtain the plaintext, but decryption can be conducted by starting from an arbitrary block. As described above, with the CBC mode, there is an interdependence of data among the ciphertext blocks, and thus the block order cannot be rearranged, and falsification can be detected (see, for example, Japanese Lain-open Patent Publication No. 2005-12466).

### SUMMARY

According to an aspect of the embodiments, a cryptographic processing apparatus that encrypts plaintext using a fixed-value common key that is shared with other cryptographic processing apparatus, includes an acquiring unit that acquires random information being used within the cryptographic processing apparatuses, an encrypting unit that encrypts encryption target data using key information and outputs encrypted data when the encryption target data and the key information is set, a transmitting unit that transmits, to the other cryptographic processing apparatus, the encrypted data, and a setting unit that sets the fixed-value common key as the key information and the random information as the encryption target data when the random information is acquired by the acquiring unit, and sets the encrypted data as the key information and at least one portion of the plaintext as the target data when the encrypted data is acquired.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one example of a communication process in accordance with a disclosed embodiment;

FIG. 2 illustrates one example of common key cipher;

FIG. 3 illustrates a network configuration of cryptographic processing apparatus;

FIG. 4 is a block diagram illustrating a hardware configuration of a cryptographic processing apparatus;

FIG. 5 is a block diagram illustrating a functional configuration of a cryptographic processing apparatus;

FIG. 6 is a flowchart illustrating a transmission processing sequence in a cryptographic processing apparatus;

FIG. 7 is a flowchart illustrating a reception processing sequence in a cryptographic processing apparatus;

FIG. 8 illustrates a CBC mode encryption process in accordance with a disclosed embodiment;

FIG. 9 illustrates one example of padding;

FIG. 10 is a flowchart illustrating an encryption processing sequence;

FIG. 11 is a flowchart illustrating a ciphertext block creation processing sequence;

FIG. 12 illustrates a CBC mode decryption process in accordance with a disclosed embodiment;

FIG. 13 is a flowchart illustrating a decryption processing sequence;

FIG. 14 is a flowchart illustrating a plaintext block generation processing sequence;

FIG. 15 is a flowchart illustrating a data check processing sequence;

FIG. 16 is a flowchart illustrating a preliminary check processing sequence;

FIG. 17 illustrates a CTR mode encryption process in accordance with a disclosed embodiment;

FIG. 18 illustrates a CTR mode decryption process in accordance with a disclosed embodiment;

FIG. 19 illustrates a related art encryption process using the ECB mode;

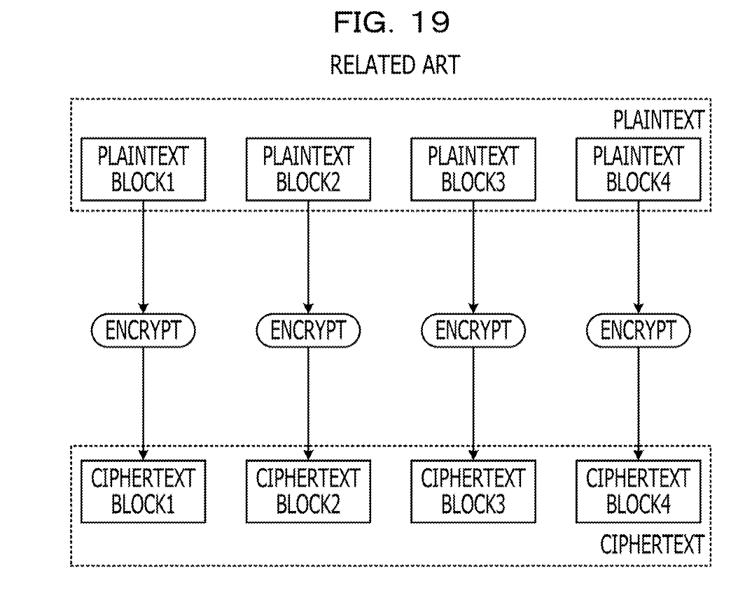

FIG. 20 illustrates a related art decryption process using the ECB mode;

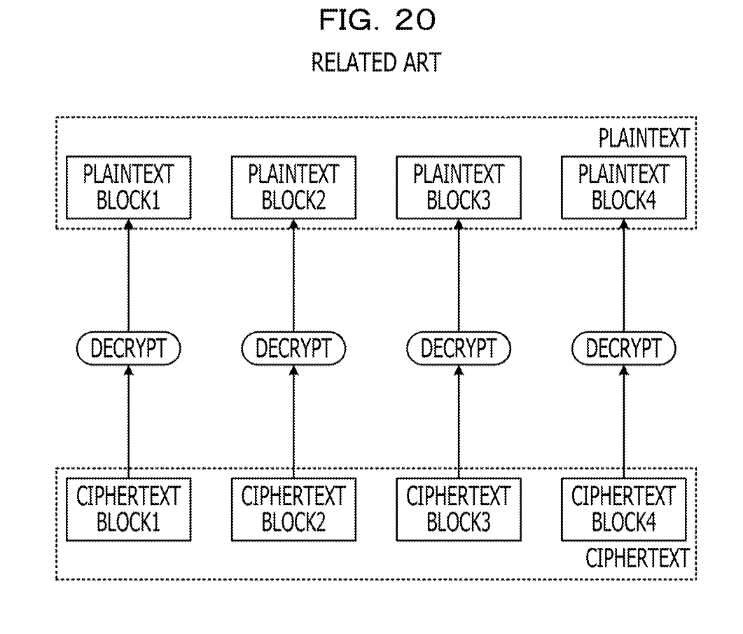

FIG. 21 illustrates a related art encryption process using the CBC mode; and

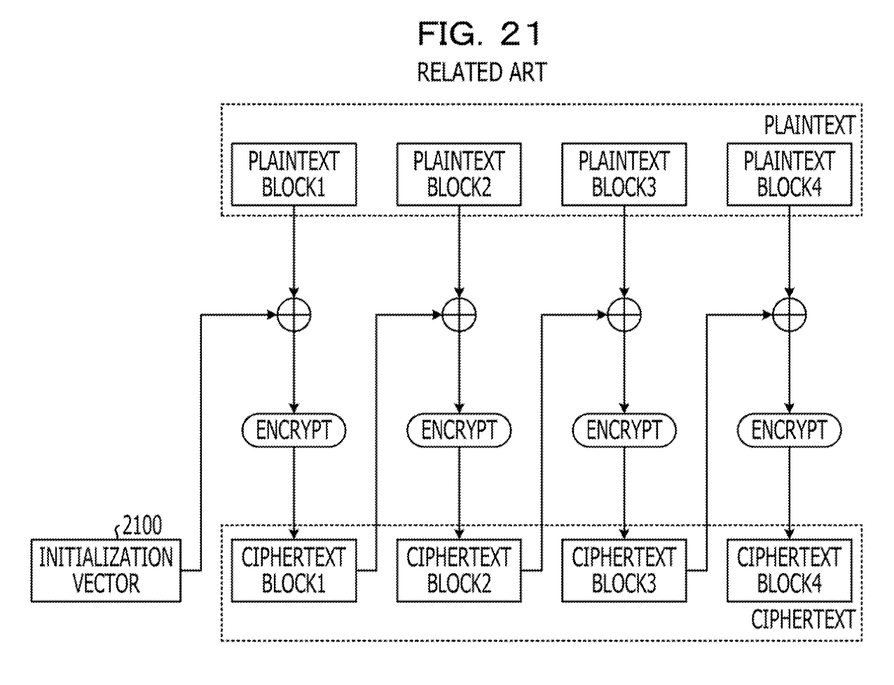

FIG. 22 illustrates a related art decryption process using the CBC mode.

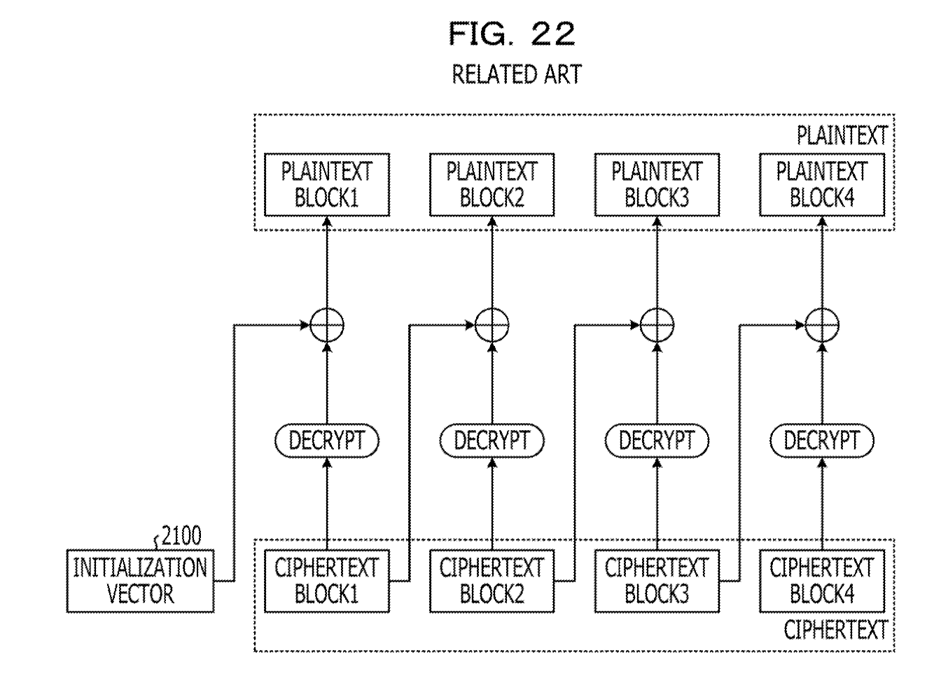

### DESCRIPTION OF EMBODIMENTS

Hereinafter, embodiments of a cryptographic processing apparatus and a cryptographic processing method in accordance with the disclosed technology will be described with reference to the drawings.

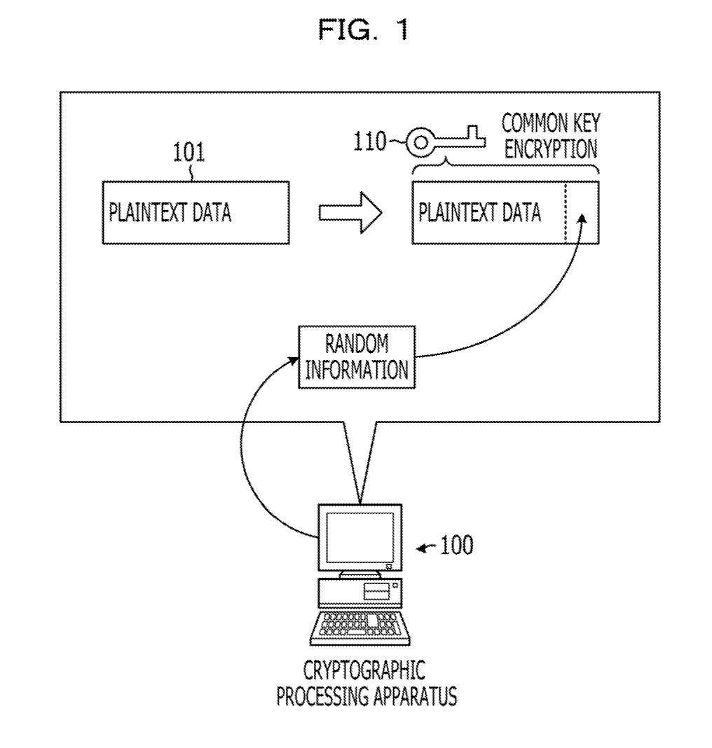

FIG. 1 illustrates one example of a communication process in accordance with a disclosed embodiment. As illustrated in FIG. 1, in the cryptographic processing apparatus 100 in accordance with a disclosed embodiment, there is acquired random information that includes random elements from among the information utilized in the ordinary processes of the cryptographic processing apparatus 100. By inserting this random information into a portion of the plaintext data 101, security strength is maintained.

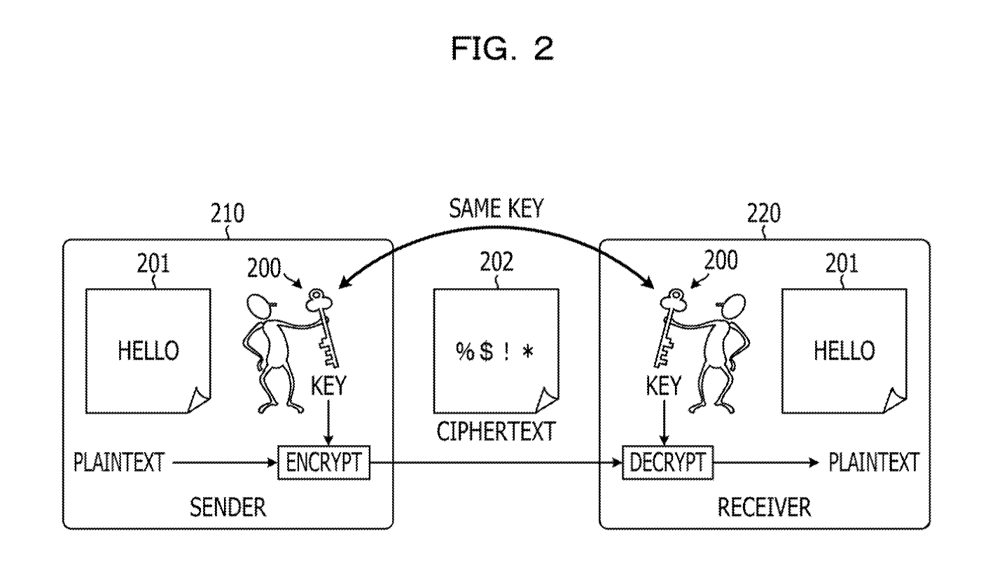

FIG. 2 illustrates one example of common key encryption. FIG. 2 will be used to describe typical common key encryption. In a common key encryption process, the sender 210 and the receiver 220 both use the same key (e.g., a common key) 200 to encrypt and decrypt data. Ordinarily, each time a communication occurs, the sender 210 prepares a complex key 200 including random information, and performs common key encryption with respect to the plaintext 201. Consequently, in order to decrypt the ciphertext 202 created at the sender 210, the key 200 that was prepared in this instance must be transmitted to the receiver 220.

In ordinary common key encryption as described above, it is necessary to prepare random information for maintaining security strength, in addition to the common key encryption algorithm. Consequently, random number generators or other functions for generating random information, or functions for externally obtaining random information, have been indispensible in cryptographic processing apparatus of the related art. However, in the case of the cryptographic processing apparatus 100 in accordance with a disclosed embodiment, random information is inserted into the plaintext data 101, as described in FIG. 1. For this reason, the common key 110 used for common key encryption may be a fixed value. In other words, the common key can be distributed among the respective cryptographic processing apparatus 100 in advance.

Consequently, since the cryptographic processing apparatus 100 utilizes random information that was already being used within the apparatus itself, it is possible to substantially eliminate the resources corresponding to the configuration of the functions for generating or externally obtaining random information, which were required in the related art. Moreover, the cryptographic processing apparatus 100 does not need to transmit the common key to the cryptographic processing apparatus at the receiver 220. Consequently, the communication load imposed by the common key transmission of the related art can be substantially eliminated, and the efficiency of communicating data over the network can be improved.

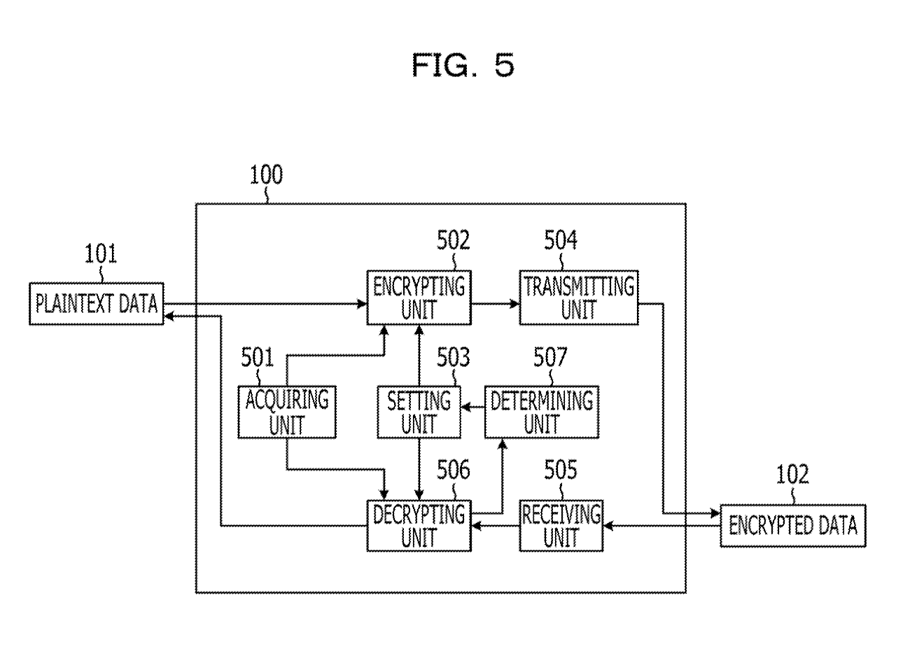

Furthermore, when the cryptographic processing apparatus 100 in accordance with a disclosed embodiment decrypts encrypted data 102 received from another cryptographic processing apparatus 100 (see FIG. 5 described later), the random information inserted into the plaintext data 101 can be utilized to perform a preliminary check of the validity or invalidity of the encrypted data 102. When a cryptographic processing apparatus 100 receives encrypted data 102 transmitted from another cryptographic processing apparatus 100, decryption is first conducted starting from the location where the random information was inserted (such as the leading portion of the plaintext data 101, for example).

Subsequently, it is determined whether or not the encrypted data 102 that was received is valid data, according to whether the information that was decrypted first is suitable as the random information of the cryptographic processing apparatus 100 set as the transmission source. If the encrypted data 102 that was received is invalid data, then the cryptographic processing apparatus 100 can discard the encrypted data 102 that was received, before decrypting the remaining data.

As described above, a cryptographic processing apparatus 100 preliminarily decrypts part of plaintext data 101 into which random information has been inserted, and checks the validity of the encrypted data 102. Consequently, it becomes possible for the cryptographic processing apparatus 100 to block encrypted data 102 that has been falsely generated, while also detecting substitution attacks by an attacker, and rejecting ciphertext blocks from the network that have been falsely generated. In so doing, network safety can be improved.

As described above, by applying a communication process in accordance with a disclosed embodiment, it becomes possible to substantially eliminate resources and common key data sizes required by encryption processes for sending and receiving data. For this reason, communication with strong security can be enabled, regardless of the network environment. Hereinafter, a specific, example configuration of a cryptographic processing apparatus 100 that realizes the above-described communication process will be described.

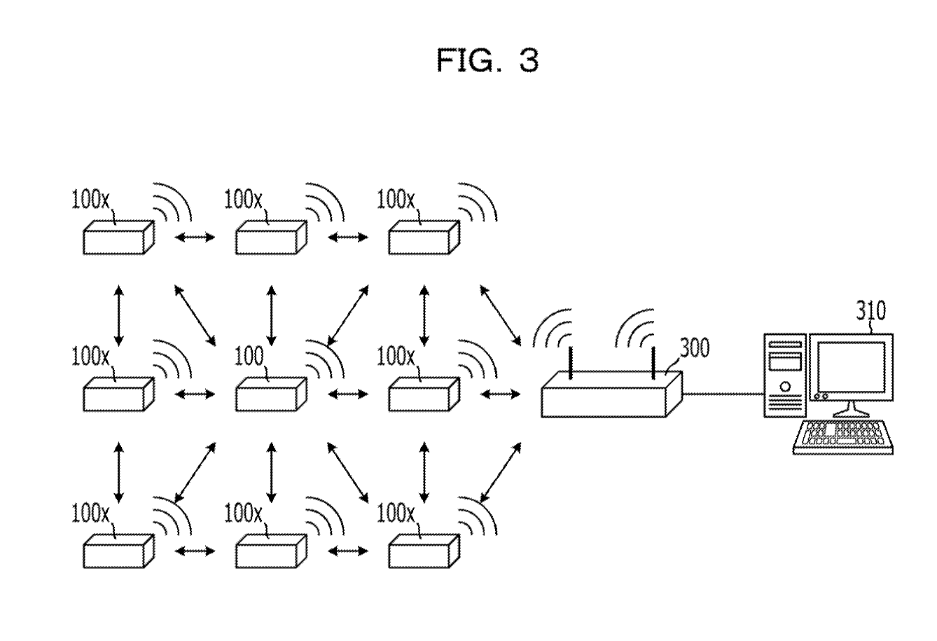

FIG. 3 illustrates a network configuration of cryptographic processing apparatus. The cryptographic processing apparatus 100 in accordance with a disclosed embodiment may be used on the basis of a network configuration like that illustrated in FIG. 3. As illustrated in FIG. 3, the cryptographic processing apparatus 100 bidirectionally communicates with a plurality of cryptographic processing apparatus 100x having similar configurations. In addition, these cryptographic processing apparatus 100 and 100x are also connected to a server 310 via a gateway 300. The server 310 is provided with a gateway 300 that governs and manages the cryptographic processing apparatus 100 and 100x.

The cryptographic processing apparatus 100 and 100x are mutual recipients of routine communication, and periodically distribute a fixed-value common key among each other. Also, the bidirectional communication among the cryptographic processing apparatus 100 and 100x realizes what is referred to as ad hoc communication. Furthermore, even if some of the cryptographic processing apparatus 100x are not routinely communicating with some of the other cryptographic processing apparatus 100x, the ad hoc network can be autonomously established via the cryptographic processing apparatus 100x that are steadily communicating.

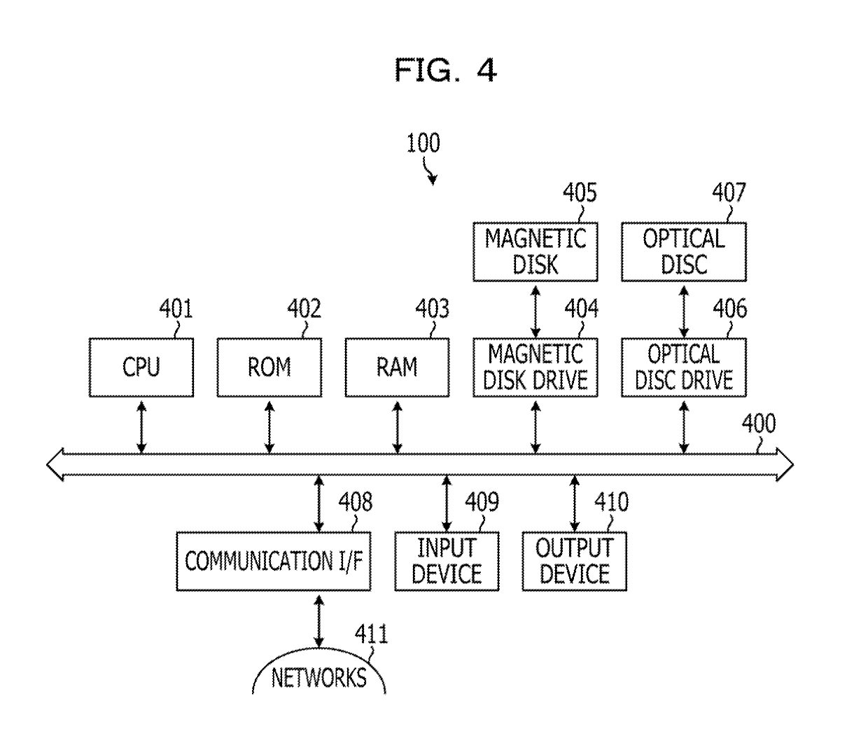

FIG. 4 is a block diagram illustrating a hardware configuration of a cryptographic processing apparatus. In FIG. 4, the cryptographic processing apparatus 100 is provided with a central processing unit (CPU) 401, read-only memory (ROM) 402, random access memory (RAM) 403, a magnetic disk drive 404, a magnetic disk 405, an optical disc drive 406, an optical disc 407, a communication interface (I/F) 408, an input device 409, and an output device 410. In addition, the individual components are respectively connected to each other by a bus 400.

Herein, the CPU 401 administers overall control of the cryptographic processing apparatus 100. The ROM 402 stores various programs, such as boot programs and communication programs, for example. The RAM 403 is used as a work area for the CPU 401. The magnetic disk drive 404 controls the reading and writing of data with respect to the magnetic disk 405, in accordance with control by the CPU 401. The magnetic disk 405 stores data written thereto under the control of the magnetic disk drive 404.

The optical disc drive 406 controls the reading and writing of data with respect to the optical disc 407, in accordance with control by the CPU 401. The optical disc 407 stores data written thereto under the control of the optical disc drive 406, and also allows a computer to read out data stored on the optical disc 407.

The communication interface (hereinafter abbreviated I/F) 408 is connected via a communication channel to various networks 411, such as a local area network (LAN), a wide area network (WAN), the Internet, or a local network. The communication I/F 408 is connected to other cryptographic processing apparatus 100x via the networks 411. In addition, the communication I/F 408 acts as an interface between the apparatus internals and the networks 411, and controls the input and output of data with respect to external apparatus. The communication I/F 408 may adopt a device such as a modem or LAN adapter, for example.

The input device 409 accepts external input entered into the cryptographic processing apparatus 100. More specifically, the input device 409 may be a device such as a keyboard or mouse, for example. In the case of a keyboard, the input device 409 may be provided with keys for inputting text, numbers, and various commands, for example, with data being input via such keys. The input device 409 may also be a device such as a touch panel or numeric keypad. In the case of a mouse, the input device 409 may move a cursor, select areas, or perform actions such as moving or changing the size of windows. Additionally, if the input device 409 is provided with functions similar to those of a pointing device, the input device 409 may also be a device such as a trackball or joystick.

The output device 410 outputs specified data, such as data that has been received at the cryptographic processing apparatus 100, or log data of the cryptographic processing apparatus 100, for example. More specifically, the output device 410 may be a device such as a display or printer, for example. In the case of a display, the output device 410 may display a cursor, icons, and toolboxes, as well as various data including text, images, and function information, for example. A device such as a CRT, TFT LCD, or plasma display may be adopted as the display. In the case of a printer, the output device 410 may print image data or document data, for example. A laser printer or inkjet printer may be adopted.

FIG. 5 is a block diagram illustrating a functional configuration of a cryptographic processing apparatus. The cryptographic processing apparatus 100 is configured to include an acquiring unit 501, an encrypting unit 502, a setting unit 503, a transmitting unit 504, a receiving unit 505, a decrypting unit 506, and a determining unit 507. These functions (e.g., the acquiring unit 501 to the determining unit 507) constitute a control unit, and it is possible for these functions to be realized as the result of causing the CPU 401 to execute a program stored in a storage device such as the ROM 402, the RAM 403, the magnetic disk 405, or the optical disc 407 illustrated in FIG. 4, for example. Alternatively, it is possible to realize these functions by hardware having such functions.

Herein, a fixed value shared with the other cryptographic processing apparatus 100x has been distributed to the cryptographic processing apparatus 100 in advance as a common key. Consequently, in the encryption and decryption operations conducted in the cryptographic processing apparatus 100, the fixed value that has been distributed is used as the common key.

The acquiring unit 501 includes functions for acquiring random information that is being used inside the cryptographic processing apparatus. Random information herein indicates information that includes random elements. The random information being used inside the cryptographic processing apparatus 100 may be time information from an internal clock, or a program counter (PC) value provided in the CPU 401, for example. Herein, random information that has been acquired is stored in a storage area of the RAM 403, magnetic disk 405, or optical disc 407, for example.

The encrypting unit 502 includes functions for taking target data and key information that has been set, and then using the key information to encrypt the target data. The target data and the key information are set by the setting unit 503. Herein, the encrypted data 102 obtained by performing encryption is stored in a storage area or the RAM 403, magnetic disk 405, or optical disc 407, for example.

The setting unit 503 includes functions for setting the target data and key information used in the encryption conducted by the encrypting unit 502. In addition, the setting unit 503 includes functions for setting decryption target data and decryption key information used in the decryption conducted by the decrypting unit 506. First, in order to describe the function units used during a transmission process, the setting process conducted by the setting unit 503 to set the target data and key information for encryption (e.g., the encryption setting process) will be described.

In the setting unit 503, a first encryption setting process and a second encryption setting process are executed. In the first encryption setting process, data including random information inserted into the leading portion of the plaintext data 101 is set as the target data. In the case of the first encryption setting process, the setting unit 503 sets the fixed value that was distributed to each cryptographic processing apparatus 100 in advance as the key information used to encrypt the random information. Once the setting unit 503 conducts the first encryption setting process, the encrypting unit 502 encrypts the target data using the set key information. Consequently, in the encrypting unit 502, the random information is encrypted using the fixed value, and then output as the encrypted data 102.

In the second encryption setting process, the remaining part of the plaintext data 101 other than the random information is set as the target data. Once the setting unit 503 conducts the second encryption setting process, the encryption unit 502 encrypts the target data using the set key information set in the first encryption setting process. At this point, by repeatedly executing the second encryption setting process, encryption is conducted until there is no more data in the plaintext data 101 that has not been set as target data.

In other words, as a result of the setting unit 503 executing the first encryption setting process, encrypted data 102 encrypting the random information is obtained from the encrypting unit 502. Subsequently, the setting unit 503 sets a predetermined amount of the data constituting the plaintext data 101 as the target data. By then executing the second encryption setting process, additional encrypted data 102 is obtained from the encrypting unit 502. The encrypted data 102 obtained at this point is the data that was set as the target data by the previous second encryption setting process (e.g., the predetermined amount of the data constituting the plaintext data 101).

The setting unit 503 then continues to conduct the second encryption setting process until there is no more data in the plaintext data 101 that has not been set as target data. In so doing, the encrypted data 102 is recreated in the form of an encrypted data group made up of segments of encrypted data 102, each having a predetermined size. This encrypted data group includes random information.

More specifically, in the first instance of the first encryption setting process, data including random information inserted into the leading portion of the plaintext data 101 is set as the target data and encrypted. Consequently, the encrypted data group includes random information. Consequently, even if the same plaintext data is encrypted with the same common key and the initialization vector, the decrypted data are not same if the random information is not same.

The transmitting unit 504 transmits the encrypted data 102 encrypted by the encrypting unit 502 to another cryptographic processing apparatus 100x set as the destination. Herein, if the cryptographic processing apparatus 100x are configured to directly communicate with each other as illustrated by way of example in FIG. 3, then the transmitting unit 504 outputs the encrypted data 102 to a channel (wired or wireless) directly connected to another cryptographic processing apparatus 100x. Meanwhile, if the cryptographic processing apparatus 100 is configured to communicate with the other cryptographic processing apparatus 100x via some kind of network, then the transmitting unit 504 outputs the encrypted data 102 to the network.

The receiving unit 505 includes functions for receiving encrypted data 102 that has been transmitted from another cryptographic processing apparatus 100x having the fixed-value common key. As described with respect to the transmitting unit 504, encrypted data is received via a channel connected to a cryptographic processing apparatus 100x or via some kind of network, depending on the how the cryptographic processing apparatus 100 is connected to the other cryptographic processing apparatus 100x. Herein, encrypted data that has been received is stored in a storage area of the RAM 403, magnetic disk 405, or optical disc 407, for example.

The decrypting unit 506 includes functions for taking decryption target data and decryption key information that has been set, and then using the decryption key information to decrypt the decryption target data and generated decrypted data. As described earlier, the decryption target data and the decryption key information are set by the setting unit 503. Besides being stored in a storage area of the RAM 403, magnetic disk 405, or optical disc 407, for example, decrypted plaintext data 101 may be output by the output device 410 as information in an arbitrary format according to user instructions.

The determining unit 507 includes functions for determining whether or not specified information is in a given format. In the determining unit 507, the decrypted data that was decrypted by the decrypting unit 506 may be set as information in a given format, such as random information, for example. The determining unit 507 is then used to determine whether or not the decrypted data includes random information in the given format. Herein, the determination results are stored in a storage area of the RAM 403, magnetic disk 405, or optical disc 407, for example.

A setting process executed by the setting unit 503 when encrypted data 102 is received will now be described. The setting unit 503 executes a first decryption setting process and a second decryption setting process. More specifically, in the first decryption setting process, the setting unit 503 sets the fixed-value common key as the decryption key information, and sets the leading data constituting the encrypted data as the decryption target data.

Furthermore, in the second decryption setting process, if random information being used inside another cryptographic processing apparatus 100x is obtained by the decrypting unit 506, then the setting unit 503 sets encrypted data 102 as the decryption target data. In other words, the second decryption setting process is executed depending on the decryption results from the first decryption setting process.

On the other hand, if the determination results from the determining unit 507 indicate that random information being used inside another cryptographic processing apparatus 100x has not been obtained by the decrypting unit 506, then the encrypted data 102 is invalid. Thus, instead of the second decryption process, the apparatus can be set to discard the encrypted data 102 before decryption by the decrypting unit 506. Meanwhile, if plaintext data is obtained in the second decryption setting process, then the second decryption setting process can be continued until there is no more encrypted data that has not been set as decryption target data. In other words, if it is determined that the encrypted data 102 is valid data, then the setting unit 503 conducts the second decryption setting process so as to automatically decrypt the remaining encrypted data 102.

Next, processing sequences for sending and receiving data by using the above cryptographic processing apparatus 100 will be described. In the cryptographic processing apparatus 100, once plaintext data 101 is received from the user as outgoing data, an encryption process is automatically performed on the plaintext data 101, and encrypted data 102 is created. Consequently, when transmitted from the cryptographic processing apparatus 100 to an arbitrary cryptographic processing apparatus 100x, the plaintext data 101 is in the state of encrypted data 102. Similarly, when the cryptographic processing apparatus 100 receives some kind of data from another cryptographic processing apparatus 100x, the data is received in the state of encrypted data 102.

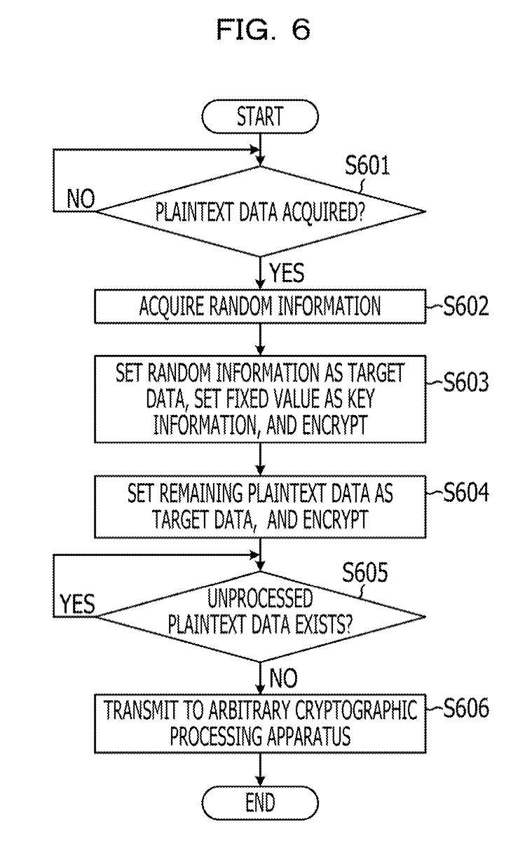

FIG. 6 is a flowchart illustrating a transmission processing sequence in a cryptographic processing apparatus. The flowchart in FIG. 6 illustrates a transmission processing sequence for when the cryptographic processing apparatus functions as a transmitter that transmits plaintext data 101 from the cryptographic processing apparatus 100 to an arbitrary cryptographic processing apparatus 100x. By executing the respective processing operations in FIG. 6, encryption is performed on the plaintext data 101, and thus the plaintext data 101 can be transmitted securely.

In FIG. 6, the cryptographic processing apparatus 100 first determines whether or not outgoing plaintext data 101 has been acquired (S601). In operation S601, the cryptographic processing apparatus 100 enters a standby state until plaintext data 101 is acquired (S601: No loop). Once plaintext data 101 is subsequently acquired (S601: Yes), the cryptographic processing apparatus 100 transitions to the process for transmitting the acquired plaintext data 101.

First, the cryptographic processing apparatus 100 acquires random information by the acquiring unit 501 (S602). Subsequently, the cryptographic processing apparatus 100 conducts encryption by the encrypting unit 502, and in accordance with the setting process of the setting unit 503. First, the random information is set as the target data and the fixed value is set as the key information by the setting unit 503. The cryptographic processing apparatus 100 then uses the set information to conduct encryption by the encrypting unit 502 (S603).

Additionally, the setting unit 503 sets the remaining plaintext data 101 as the target data. The cryptographic processing apparatus 100 then uses the set information to conduct encryption by the encrypting unit 502 (S604).

Subsequently, the cryptographic processing apparatus 100 determines whether or not unprocessed plaintext data 101 exists (S605). If it is determined in S605 that unprocessed plaintext data 101 does exist (S605: Yes), then the cryptographic processing apparatus 100 returns to the processing operation in S604, and successively encrypts the unprocessed plaintext data 101. If it is subsequently determined in S605 that unprocessed plaintext data 101 does not exist (S605: No), then the cryptographic processing apparatus 100 transmits the encrypted data 102 to an arbitrary cryptographic processing apparatus 100x set as the destination, by the transmitting unit 504 (S606). The series of transmission processing operations according to the sequence described above is then terminated.

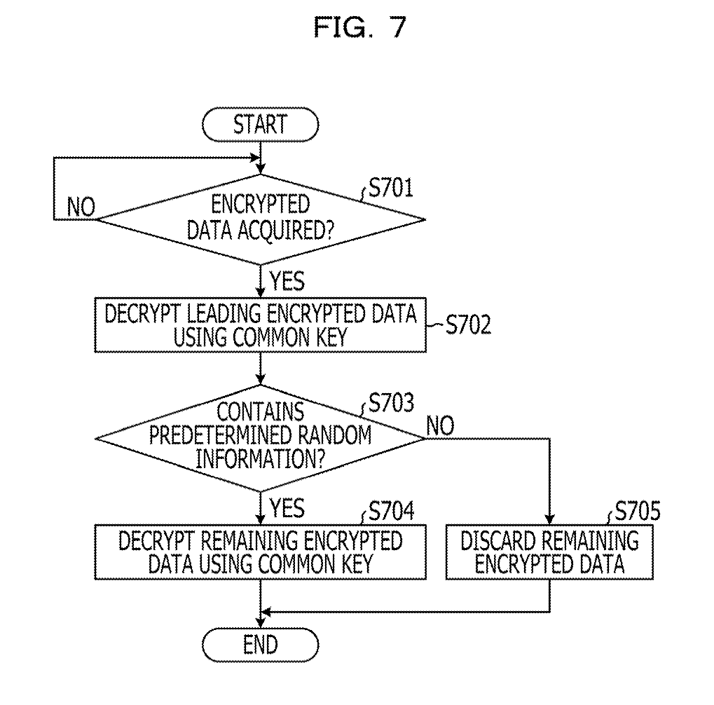

FIG. 7 is a flowchart illustrating a reception processing sequence in a cryptographic processing apparatus. The flowchart in FIG. 7 illustrates a reception processing sequence for when the cryptographic processing apparatus 100 functions as a receiver that receives encrypted data 102 transmitted from an arbitrary cryptographic processing apparatus 100x. By executing the respective processing operations in FIG. 7, a preliminary invalidity determination is made, thereby substantially suppressing unnecessary decryption when invalid encrypted data 102 is received.

In FIG. 7, the cryptographic processing apparatus 100 first determines whether or not encrypted data 102 has been received by the decrypting unit 506 (S701). In S701, the cryptographic processing apparatus 100 enters a standby state until encrypted data 102 is received (S701: No loop). Once encrypted data 102 is received in S701 (S701: Yes), the cryptographic processing apparatus 100 decrypts the leading portion of the encrypted data 102 by means of the decrypting unit 506, and using the common key (S702).

The cryptographic processing apparatus 100 then uses the determining unit 507 to determine whether or not the decrypted plaintext data 101 includes predetermined random information (S703). If it is determined in S703 that the plaintext data 101 does contain predetermined random information (S703: Yes), then the cryptographic processing apparatus 100 determines that the received encrypted data 102 is valid information. Consequently, the cryptographic processing apparatus 100 decrypts the remaining encrypted data 102 by the decrypting unit 506, and using the common key (S704). The series of reception processing operations is then terminated.

In contrast, if it is determined in S703 that the plaintext data 101 does not include predetermined random information (S703: No), then the cryptographic processing apparatus 100 determines that the received encrypted data 102 is invalid information. Consequently, the cryptographic processing apparatus 100 discards the remaining encrypted data 102 (S705), and the series of reception processing operations is terminated.

The foregoing thus describes transmission and reception processing sequences executed by a cryptographic processing apparatus 100 in accordance with a disclosed embodiment. However, the specific computations performed in the encrypting unit 502 and the decrypting unit 506 will differ depending on the type of common key encryption mode that is implemented. Also, depending on which common key encryption mode is implemented, disparities will occur in the merits that accompany the application of the cryptographic processing apparatus 100. Consequently, specific cases of encryption and decryption will be hereinafter described, taking the CBC mode and the CTR mode as two examples of the common key encryption mode.

First, CBC mode encrypted communication using the cryptographic processing apparatus 100 will be described. The CBC mode is encrypted communication that partitions plaintext into blocks, and uses the ciphertext blocks encrypting respective plaintext blocks as key information for subsequent plaintext blocks. The merits of implementing CBC mode are: 1) different ciphertext blocks are obtained, even when the plaintext blocks are the same; 2) parallelization of decryption is possible (parallel encryption is not possible); 3) the decryption order of ciphertext blocks can be changed; and 4) there is a high degree of securely. On the other hand, the CBC mode has the following demerits: 1) an initialization vector is required; 2) padding (later described in detail) is required; and 3) the encryption cannot be parallelized.

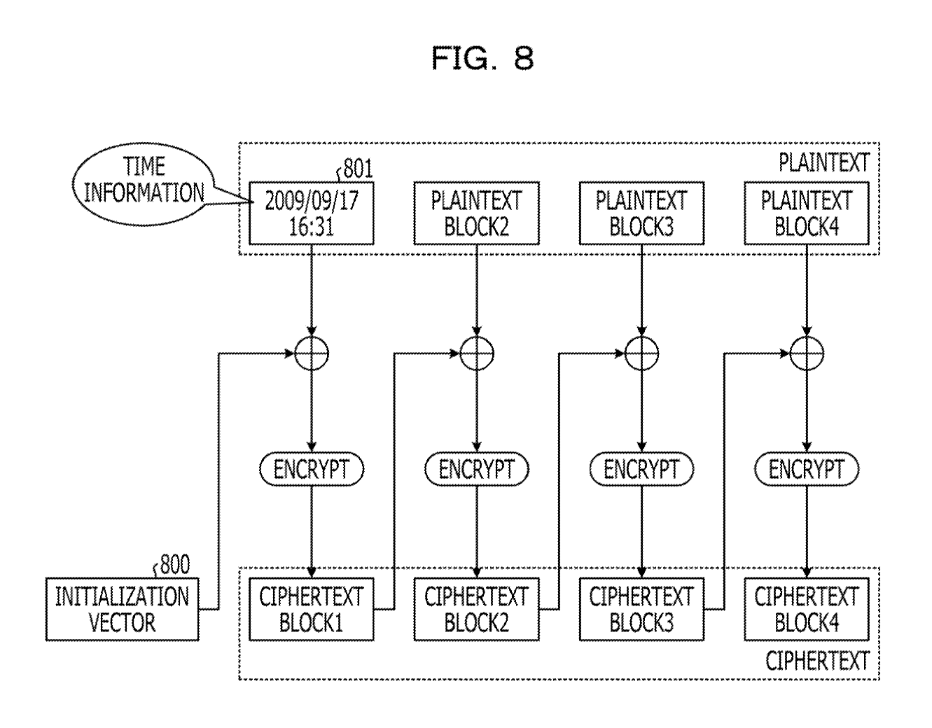

FIG. 8 illustrates a CBC mode encryption process in accordance with a disclosed embodiment. The requirement of an initialization vector was given as a demerit of the CBC mode, but in the case of the cryptographic processing apparatus 100, random information is placed at the head of the plaintext. For this reason, an arbitrary, fixed value may be prepared for use as the initialization vector 800.

In the example illustrated in FIG. 8, time information 801 being used inside the cryptographic processing apparatus 100 is inserted at the head of the plaintext as random information. In addition, in the case of the CBC mode, the plaintext is partitioned into equal units having a predetermined data size, and the plaintext blocks 1 (the time information 801) to 4 are created. During encryption, the cryptographic processing apparatus 100 first computes the exclusive disjunction of the initialization vector 800 and the time information 801 (e.g., the target data). By performing an arbitrary encryption process on the computed result, the ciphertext block 1 is created.

Subsequently, the cryptographic processing apparatus 100 computes the exclusive disjunction of the ciphertext block 1 and the plaintext block 2 (e.g., the target data). By performing an arbitrary encryption process on the computed result, the ciphertext block 2 is created. The cryptographic processing apparatus 100 similarly processes all plaintext blocks, creating the ciphertext block n+1 from the plaintext block n+1 by using the ciphertext block n created immediately prior. Herein, each plaintext block is a partitioned unit having a predetermined data size, but depending on the data length of the plaintext, the data size of the last plaintext block might not satisfy a predetermined value. However, the plaintext blocks may not be properly decrypted if their data sizes differ. Consequently, padding may become necessary to adjust the data size of the last plaintext block so as to have the same data size as the other plaintext blocks.

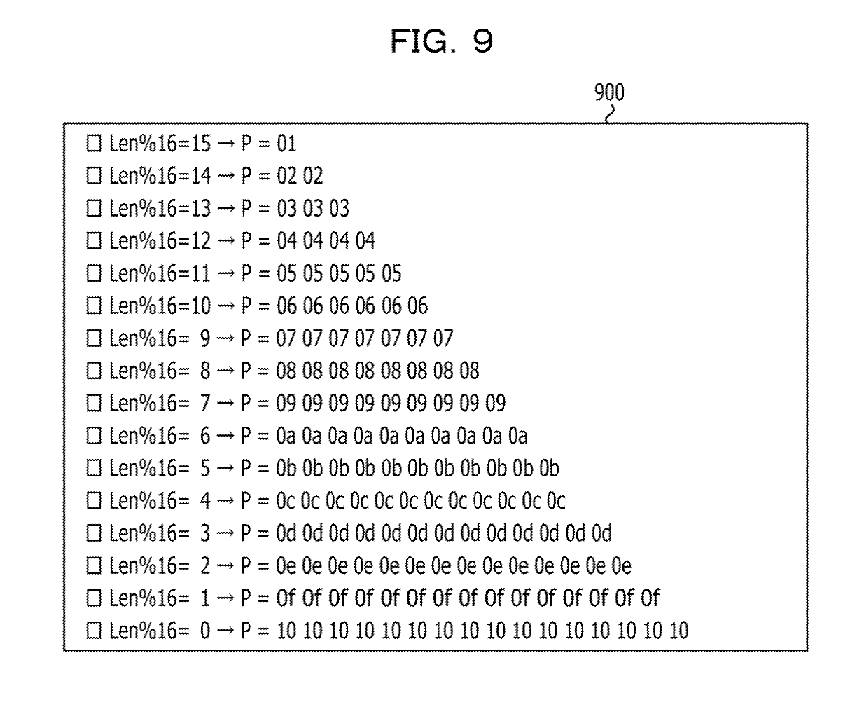

FIG. 9 illustrates one example of padding. Padding refers to a technology for compensating encryption target data so as to match a multiple of a predetermined block length (such as 128 bits, for example). The data sequence 900 illustrated by way of example in FIG. 9 represents set content in PKCS#7 padding, which is one example of padding. In PKCS#7 padding, padding data P determined by the data sequence 900 is added to the end of the target data M, with the amount of padding data P depending on the data length of the target data M. By adding the padding data P, the data length of the target data M becomes a multiple of 128 bits, and the data sizes of respectively partitioned blocks will become equal.

As one example, if the target data M equals “a4 67 83 26 51 24 f0 45 10 9b 12”, then padding data P equal to “05 05 05 05 05” will be added to create “a4 67 83 26 51 24 f0 45 10 9b 12 05 05 05 05 05”. Herein, when the cryptographic processing apparatus 100 has decrypted padded ciphertext, the last byte of the padded data is referenced, and a number of bytes equal to value expressed by the last byte is deleted from the end of the plaintext. For this reason, the plaintext is not altered.

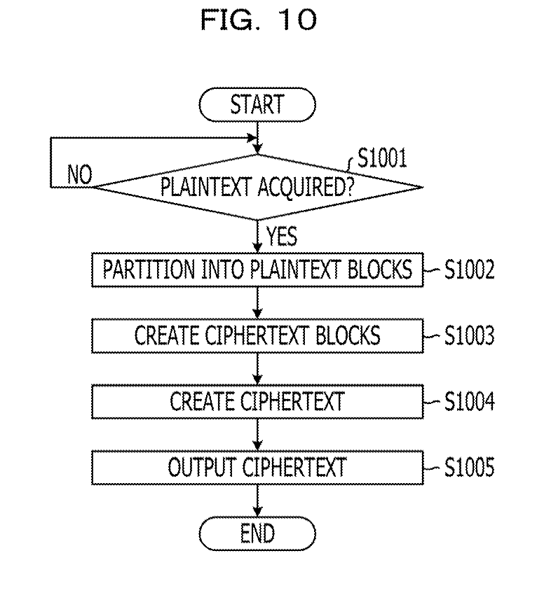

Next, an encryption sequence using the CBC mode will be described. FIG. 10 is a flowchart illustrating an encryption processing sequence. In FIG. 10, the cryptographic processing apparatus 100 first determines whether or not an outgoing plaintext has been acquired (S1001). In S1001, the cryptographic processing apparatus 100 enters a standby state until a plaintext is acquired (S1001: No loop).

Once it is determined in S1001 that a plaintext has been acquired (S1001: Yes), the cryptographic processing apparatus 100 partitions the plaintext into plaintext blocks (S1002). Subsequently, the cryptographic processing apparatus 100 creates ciphertext blocks from the plaintext blocks (S1003), and additionally creates a ciphertext from the created ciphertext blocks (S1004). Lastly, the created ciphertext is output (S1005), and the series of encryption processing operations is terminated.

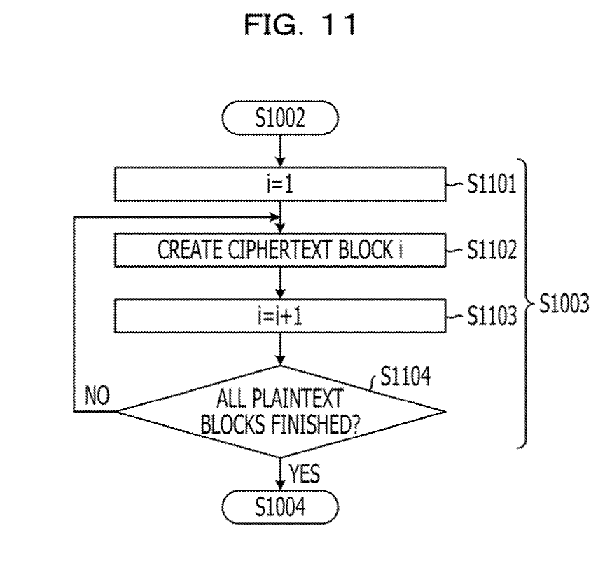

FIG. 11 is a flowchart illustrating a ciphertext block creation processing sequence. FIG. 11 illustrates the detailed processing operations conducted in S1003 of FIG. 10. In FIG. 11, the cryptographic processing apparatus 100 sets a variable i to an initial value of 1 when triggered by the completion of S1002 (S1101). Next, the cryptographic processing apparatus 100 creates the ciphertext block i from the plaintext block i and the ciphertext block i−1 (S1102).

Describing S1102 in further detail, the cryptographic processing apparatus 100 computes the exclusive disjunction on a bit-wise basis between the plaintext block i, and the ciphertext block i−1 that was obtained by encrypting information using common key block cipher. However, in the sole case where i=1, the ciphertext block 1 is created from the plaintext block 1 and the initialization vector 800. In other words, in S1102, the cryptographic processing apparatus 100 is computing the exclusive disjunction on a bit-wise basis between data that was obtained by encrypted the plaintext block 1 using common key block cipher, and the initialization vector.

Subsequently, the cryptographic processing apparatus 100 increments the variable i by +1 (S1103), and determines whether or not encryption has finished for all plaintext blocks (S1104). If it is determined in S1104 that a plaintext block exists for which encryption is not finished (S1104: No), then the cryptographic processing apparatus 100 returns to the processing operation in S1102, and creates the next ciphertext block i. Once it is subsequently determined in S1104 that encryption has finished (S1104: Yes), the cryptographic processing apparatus 100 transitions to the processing operation in S1004.

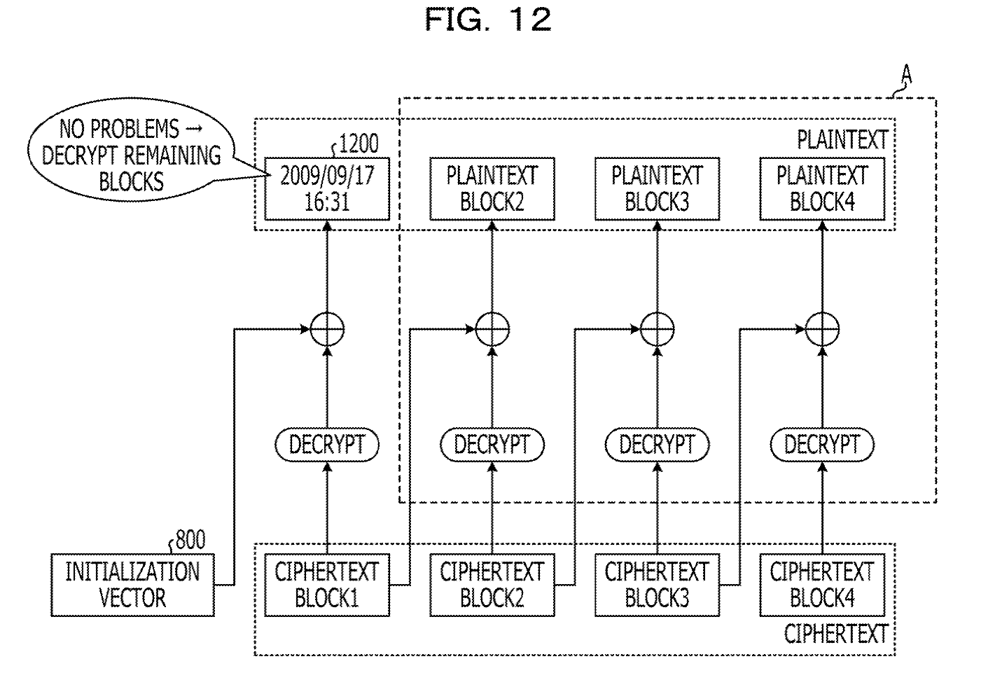

FIG. 12 illustrates a CBC mode decryption process in accordance with a disclosed embodiment. Decryption using the CBC mode will now be described. As illustrated in FIG. 12, once the ciphertext block 1 at the head of the ciphertext has been decrypted, the cryptographic processing apparatus 100 creates the plaintext block 1 by computing the exclusive disjunction of the decrypted ciphertext block 1 and the initialization vector 800. If the created plaintext block 1 is the time information 1200, then the cryptographic processing apparatus 100 determines that the ciphertext poses no problems, and decrypts the remaining ciphertext blocks.

At this point, if the plaintext block 1 is not the time information 1200, then the cryptographic processing apparatus 100 determines that there is a problem with the ciphertext, and discards the remaining ciphertext blocks. In other words, by checking the plaintext block 1, the cryptographic processing apparatus 100 is able to substantially eliminate the processing in the region A of FIG. 12 (which would be unauthorized processing if given invalid data).

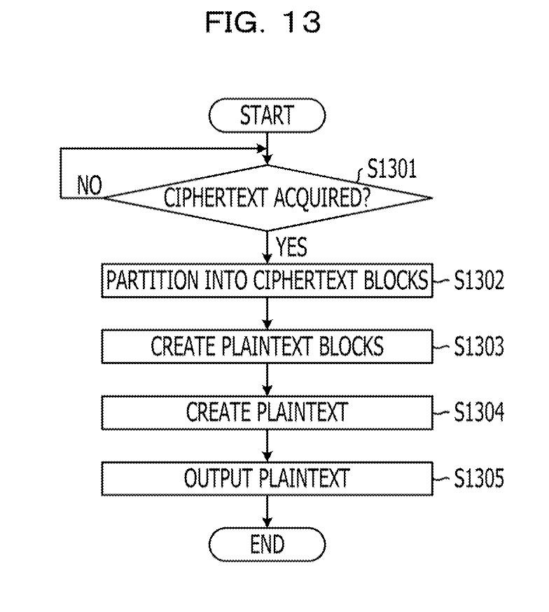

Next, a decryption sequence using the CBC mode will be described. FIG. 13 is a flowchart illustrating a decryption processing sequence. In FIG. 13, the cryptographic processing apparatus 100 first determines whether or not a ciphertext transmitted from another cryptographic processing apparatus 100x has been acquired (S1301). In S1301, the cryptographic processing apparatus 100 enters a standby state until a ciphertext is acquired (S1301: No loop).

Once it is determined in S1301 that a ciphertext has been acquired (S1301: Yes), the cryptographic processing apparatus 100 partitions the ciphertext into ciphertext blocks (S1302). Subsequently, the cryptographic processing apparatus 100 creates plaintext blocks from the ciphertext blocks (S1303), and also creates a plaintext from the created plaintext blocks (S1304). Lastly, the created plaintext is output (S1305), and the series of decryption processing operations is terminated.

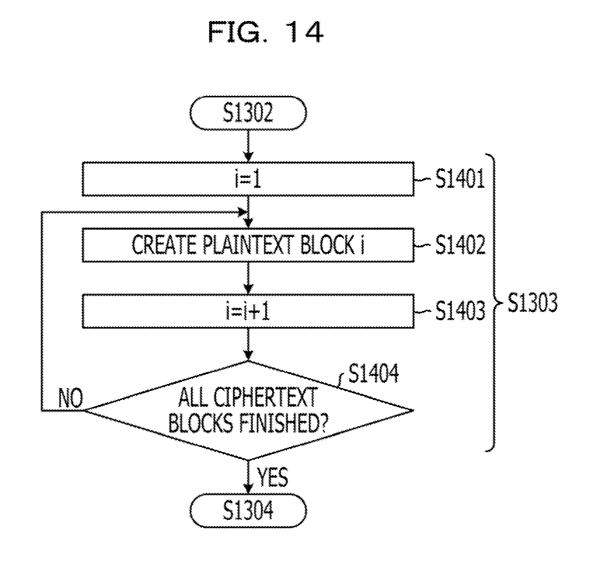

FIG. 14 is a flowchart illustrating a plaintext block generation processing sequence. The flowchart in FIG. 14 illustrates the detailed processing operations conducted in S1303 of FIG. 13. In FIG. 14, the cryptographic processing apparatus 100 first sets a variable i equal to 1 upon completion of the processing in S1302 (S1401).

Subsequently, the cryptographic processing apparatus 100 decrypts the leading ciphertext block from among the non-decrypted ciphertext blocks, and creates the plaintext block i (e.g., the leading ciphertext block 1 becomes the plaintext block 1) (S1402). Once the plaintext block i is created, the cryptographic processing apparatus 100 increments the variable i by +1 (S1403), and determines whether or not decryption has finished for all non-decrypted ciphertext blocks (S1404).

If it is determined in S1404 that decryption has not finished for all the non-decrypted ciphertext blocks (S1404: No), then the cryptographic processing apparatus 100 returns to the processing operation in S1402, and creates the incremented plaintext block i. The cryptographic processing apparatus 100 repeatedly executes the processing operations in S1402 and S1403 until decryption has finished for all non-decrypted ciphertext blocks is reached. Once it is determined in S1404 that decryption has finished for all ciphertext blocks (S1404: Yes), the cryptographic processing apparatus 100 terminates the plaintext block generation process, and transitions to the processing operation in S1304.

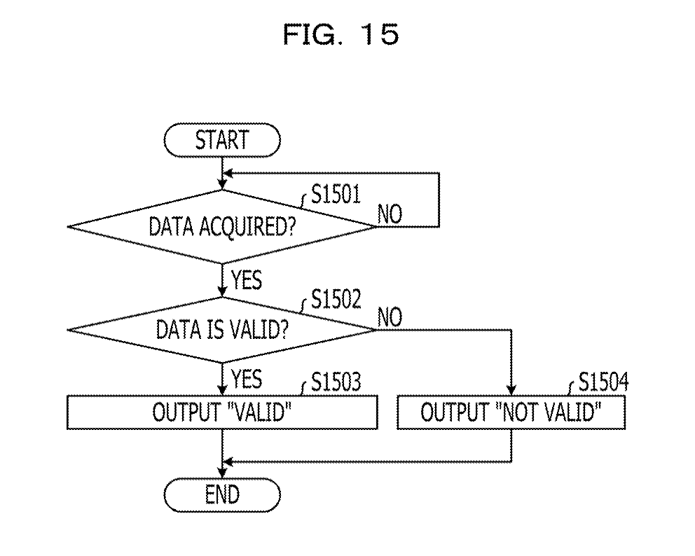

FIG. 15 is a flowchart illustrating a data check processing sequence. FIG. 15 illustrates a sequence for determining data to be valid or invalid according to whether or not data acquired by the cryptographic processing apparatus 100 has a predetermined structure. The process in FIG. 15 is used in a preliminary check of the plaintext block 1.

In FIG. 15, the cryptographic processing apparatus 100 first determines whether or not data to be determined has been acquired (S1501). In S1501, the cryptographic processing apparatus 100 enters a standby state until such data is acquired (S1501: No loop). Once it is subsequently determined in S1501 that such data has been acquired (S1501: Yes), the cryptographic processing apparatus 100 checks if the acquired data is valid (S1502).

If it is determined that the acquired data is valid (S1502: Yes), then the cryptographic processing apparatus 100 outputs information indicating “Valid” (S1503), and the series of data check processing operations is terminated. In contrast, if it is determined that the acquired data is not valid (S1502: No), then the cryptographic processing apparatus 100 outputs information indicating “Not valid” (S1504), and the series of data check processing operations is terminated.

Herein, the determination of data validity in S1502 can be arbitrarily set by the user, and may be conducted on the basis of the following example criteria: does the input data have the expected data length? is sub-data within the data arranged in the expected order? are sub-data values within their expected ranges? is sub-data stated in the expected format?

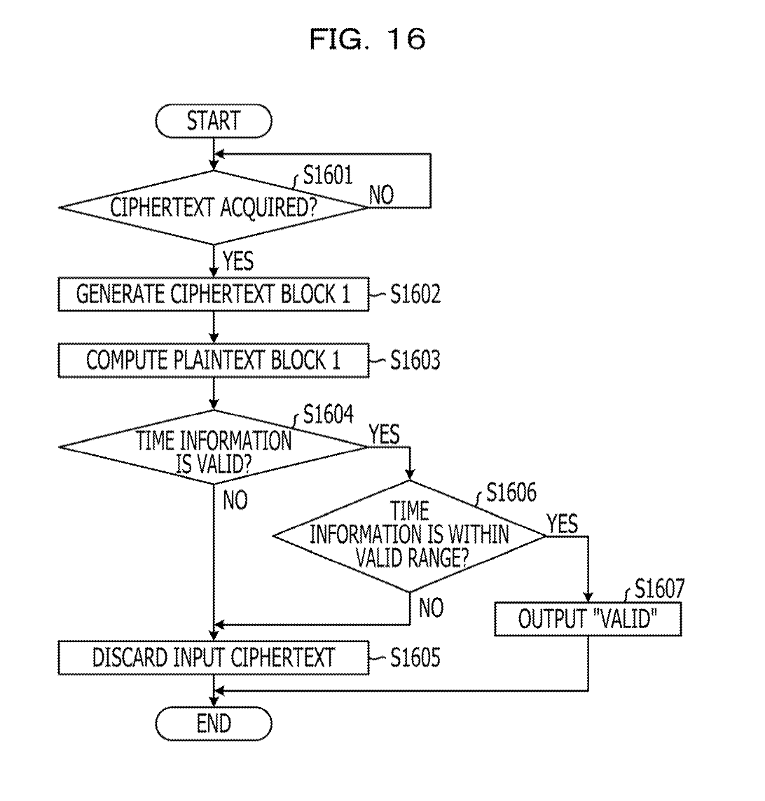

FIG. 16 is a flowchart illustrating a preliminary check processing sequence. The flowchart in FIG. 16 illustrates a sequence for retrieving the first ciphertext block of a received ciphertext, converting the first ciphertext block into a plaintext block with the use of an initialization vector, and conducting a data check with respect to the converted plaintext block. By executing the respective processing operations in FIG. 16, the ciphertext can be preliminarily determined to be valid/invalid, and unnecessary decryption processing with respect to an invalid ciphertext can be substantially prevented.

In FIG. 16, the cryptographic processing apparatus 100 first determines whether or not a ciphertext has been acquired (S1601). In S1601, the cryptographic processing apparatus 100 enters a standby state until a ciphertext is acquired (S1601: No loop).

If it is determined in S1601 that a ciphertext has been acquired (S1601: Yes), then the cryptographic processing apparatus 100 generates the ciphertext block 1 (S1602), and uses the ciphertext block 1 and an initialization vector to compute the plaintext block 1 (S1603). In other words, in S1603, the cryptographic processing apparatus 100 computes the exclusive disjunction on a bit-wise basis between data that was obtained by decrypting the ciphertext block 1 using common key block cipher, and the initialization vector.

Subsequently, the cryptographic processing apparatus 100 extracts time information from the plaintext block 1 that was computed in S1603, and determines whether or not the time information is valid (S1604). For example, in S1604, if the time information includes information regarding the calendar year, month, day, weekday, hour, minutes, seconds, and microseconds, then it can be determined if the respective data values corresponding to this information are valid as data that express such information.

If it is determined in S1604 that the time information is not valid (S1604: No), then the cryptographic processing apparatus 100 discards the input ciphertext (S1605), and the series of check processing operations is terminated.

In contrast, if it is determined in S1604 that the time information is valid (S1604: Yes), then the cryptographic processing apparatus 100 additionally determines if the range of the time information is valid (S1606). The range of the time information is set according to the network policy of the network to which the cryptographic processing apparatus 100 belongs. For example, the cryptographic processing apparatus 100 may be assumed to operate under a policy stating that packets up to one day prior to communication on the expected ad hoc network shall be received, but that any packets older than the above shall not be received.

In the case of the above policy, it is determined in S1606 if the time information expresses a time that is within one day from the present time. If it is then determined in S1606 that the time information is not included within the valid range (S1606: No), then the cryptographic processing apparatus 100 judges that the input ciphertext is not valid, and discards the input ciphertext (S1605). The series of check processing operations is then terminated.

In contrast, if it is determined in S1606 that the time information is included within the valid range (S1606: Yes), then the cryptographic processing apparatus 100 judges that the plaintext block 1 is valid, and outputs information indicating “Valid” (S1607). The series of check processing operations is then terminated.

As described above, the cryptographic processing apparatus 100 conducts a decryption process and a decrypted data check regarding the ciphertext block 1 of an input ciphertext. Thus, if the ciphertext is not valid, it becomes possible to discard the data at a preliminary stage. In particular, attackers who mount denial-of-service attacks against a network may transmit large numbers of packets to the network, but do not hold valid keys for encryption and decryption. Consequently, when a packet transmitted by an attacker is decrypted at the cryptographic processing apparatus 100, that packet will be discarded at the preliminary check stage. Furthermore, by decrypting and checking just the leading ciphertext block, the cryptographic processing apparatus 100 is able to check the entire ciphertext, and can be made to function as detection and countermeasure technology against denial-of-service attacks.

Meanwhile, attackers who mount replay attacks against a network receive and store valid packets flowing through the network, and transmit those packets to the network during an attack. However, the time information will fall outside the valid range, and thus by inspecting the range of the time information by the processing operation in S1606, packets transmitted by an attacker can be discarded.

Next, counter (CTR) mode encrypted communication using the cryptographic processing apparatus 100 will be described. The CTR mode is encrypted communication that conducts common key encryption by using a variable counter CTR that fulfills the role of a counter. The merits of implementing CTR mode are: 1) padding is unnecessary; 2) processing operations are the same for both encryption and decryption; 3) advance calculation is possible for encryption and decryption; and 4) parallelization of encryption and decryption is possible. On the other hand, one demerit of CTR mode is that an initialization vector including random elements may become necessary.

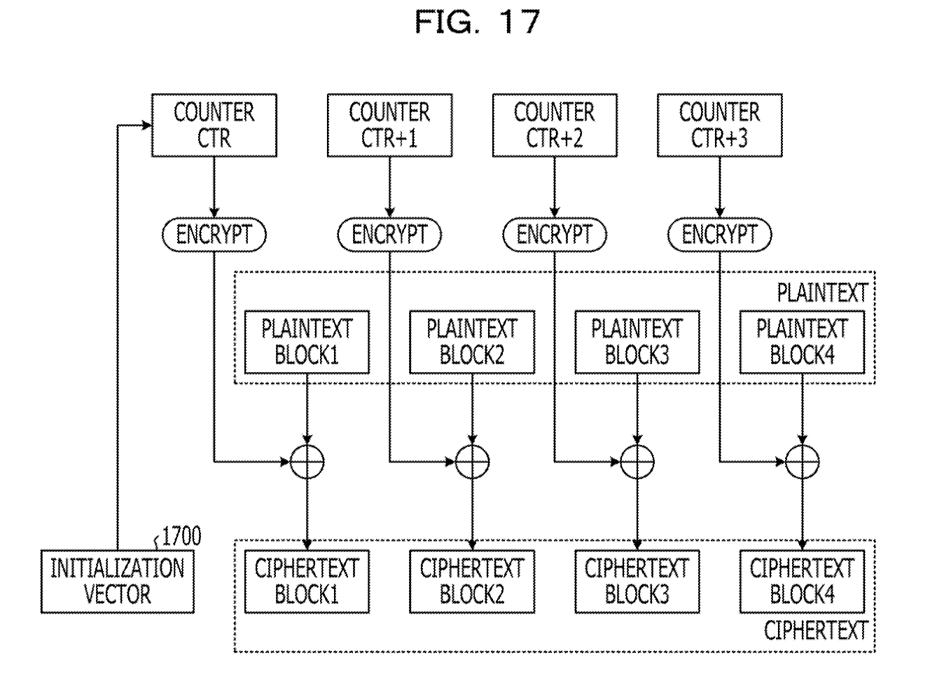

FIG. 17 illustrates a CTR mode encryption process in accordance with a disclosed embodiment. As illustrated in FIG. 17, in the case of CTR mode, a variable counter CTR is determined from an initialization vector 1700, and then subsequent counters CTR+1, CTR+2, . . . , CTR+n are also uniquely determined. Each plaintext block is then encrypted using the variable counters CTR thus determined as keys.

In the case of CTR mode as described above, the value of the counter CTR is determined by the initialization vector 1700. Unlike the CBC mode, CTR mode does not involve using the ciphertext block of the preceding plaintext block for each plaintext block, but instead involves using the variable counter CTR as determined from the initialization vector 1700. Consequently, if there are no random elements in the variable counter CTR itself, then the encryption keys will not include random information, and the encryption strength will drop significantly.

Consequently, when implementing the CTR mode, a fixed value cannot be substituted in for the initialization vector 1700 like in the CBC mode. Consequently, it may be necessary for the cryptographic processing apparatus 100 to be provided with a mechanism for generating or acquiring an initialization vector. Additionally, it may be necessary to transmit the initialization vector 1700 to the receiving cryptographic processing apparatus 100x.

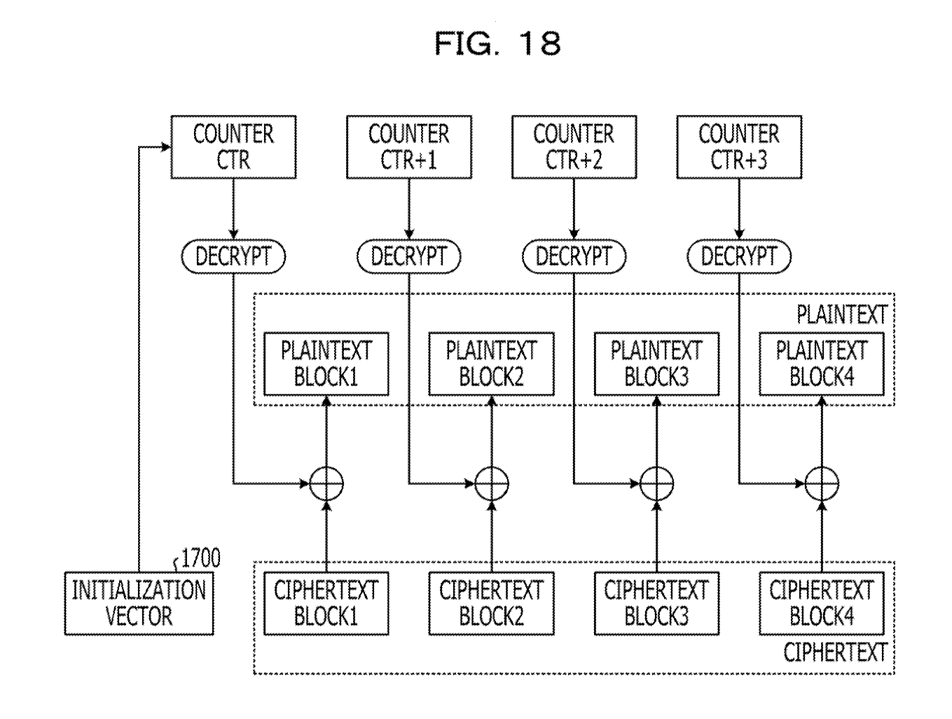

FIG. 18 illustrates a CTR decryption process in accordance with a disclosed embodiment. As illustrated in FIG. 18, in the case of CTR mode, decryption can be conducted by the same processing operations as for encryption, if an initialization vector 1700 is acquired. It should also be appreciated that decryption in CTR mode may also involve decrypting the leading ciphertext block 1 first, and then preliminarily determining the ciphertext to be valid/invalid by conducting a format check. Consequently, it is desirable to apply communication processes using the CTR mode to cryptographic processing apparatus 100 for which decryption processing efficiency is a first priority.

As described earlier, according to a cryptographic processing apparatus and method in accordance with a disclosed embodiment, random information is acquired from among information being used within a cryptographic processing apparatus, and then inserted into plaintext. In so doing, common key encryption with high encryption strength becomes possible, even when a common, fixed value is used as key information. By utilizing random information being used within the cryptographic processing apparatus as in the disclosed technology, mechanisms for generating or acquiring random value can be substantially eliminated. Furthermore, since processes for transmitting the common key become unnecessary, it becomes possible to reduce the processing load on the cryptographic processing apparatus 100 and communication channels, thereby enabling encrypted communication unconstrained by the network environment.

Also, in the above technology, functions for encrypting plaintext in units of predetermined data size are provided. In so doing, the quantity of encrypted data can be distributed to correspond with communication channel capacity. Consequently, safe transmission and reception of even large quantities of plaintext data can be realized, regardless of the capacity of the communication channel connected to the cryptographic processing apparatus 100.

Moreover, the foregoing technology may also be configured such that, when encrypted data is received, a fixed value distributed in advance as the common key is used as the decryption key to decrypt the leading portion of the encrypted data. With such a configuration, by inserting check information (such as time information) into the leading portion of the encrypted data, the validity of the encrypted data can be determined at a preliminary stage of the decryption, and unnecessary processing can be substantially eliminated.

In addition, when determining the validity of encrypted data at a preliminary stage as in the above technology, functions for automatically discarding encrypted data before decrypting that data can be provided. Doing so makes it possible to avoid situations where communication functions become paralyzed as a result of large amounts of invalid packets from an attacker or other source.

Furthermore, in the above technology, time information can be adopted as the random information used for maintaining encryption strength. In so doing, communication processes in accordance with a disclosed embodiment can be applied to all types of communication equipment.

Using time information as the random information also makes it possible to impart randomness within the data. Consequently, even when a fixed value is used as the initialization vector, encryption and decryption processes using the CBC mode of common key block cipher can be realized, without lowering the level of safety. In cases where time information is already required information in the plaintext, it becomes possible to realize encryption and decryption processes using the CBC mode of common key block cipher without increasing the plaintext information. For this reason, the data communication efficiency over the network can be improved.

Furthermore, the cryptographic processing apparatus and processing method in accordance with a disclosed embodiment are able to determine whether or not a ciphertext is an invalid packet from information obtained by decrypting just the leading block from among the ciphertext blocks constituting the ciphertext. Even if an invalid packet is received, it becomes possible to discard the invalid packet without conducting unnecessary decryption processing operations with respect to the remaining ciphertext blocks. Meanwhile, even if a valid packet is received, almost no delay or additional circuitry is incurred when using the disclosed techniques.

In particular, it is desirable to apply the cryptographic processing apparatus and processing method in accordance with a disclosed embodiment to network environments that are subject to a form of attack referred to as a denial-of-service (DoS) attack. In a DoS attack, the attacker transmits large numbers of packets to a network, with the aim of shutting down network functions. Consequently, the discarding of invalid packets at a preliminary stage as described earlier is highly effective as a countermeasure against DoS attacks.

In addition, another well-known form of attack against a network is referred to as a replay attack. In a replay attack, the attacker acquires and retains legitimate packets in advance, and then re-transmits these packets to the network, with the aim of lowering service functionality and causing service malfunction. Although various techniques have been established as countermeasures against replay attacks, a configuration that discards packets whose time information falls outside a predetermined range, as in the cryptographic processing apparatus and processing method in accordance with a disclosed embodiment, has a secondary advantage of enabling countermeasures against replay attacks.

Herein, the cryptographic processing method in accordance with a disclosed embodiment may be realized as a result of a personal computer, workstation, or other computer executing a program that has been prepared in advance. The program may be stored on a computer-readable recording medium, such as a hard disk, flexible disk, CD-ROM, MO, or DVD, and may be executed as a result of being read out from the recording medium by a computer. Alternatively, the communication program may also be distributed via a network such as the Internet.

Meanwhile, the cryptographic processing apparatus 100 in accordance with a disclosed embodiment may be realized by means of an application-specific integrated circuit (hereinafter abbreviated ASIC) such as a standard cell or structured ASIC, or by means of a programmable logic device (PLD) such as an FPGA. As a more specific example, the functions of the foregoing cryptographic processing apparatus 100 (e.g., the acquiring unit 501 to the determining unit 507) may be functionally defined by means of HDL statements. By logically synthesizing and applying these HDL statements to an ASIC or PLD, a cryptographic processing apparatus 100 can be manufactured.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A cryptographic processing apparatus that encrypts plaintext using a fixed-value common key that is shared with other cryptographic processing apparatus, comprising:
an acquiring unit that acquires random information being used within the cryptographic processing apparatuses;
an encrypting unit that encrypts encryption target data using key information and outputs encrypted data when the encryption target data and the key information is set;
a transmitting unit that transmits, to the other cryptographic processing apparatus, the encrypted data; and
a setting unit that sets the fixed-value common key as the key information and the random information as the encryption target data when the random information is acquired by the acquiring unit, and sets at least one portion of the plaintext as the target data when the encrypted data is acquired.

2. The cryptographic processing apparatus according to claim 1, wherein
the acquiring unit acquires time information being used within the cryptographic processing apparatus as the random information being used within the cryptographic processing apparatus.

3. The cryptographic processing apparatus according to claim 1, wherein
the encrypting unit first partitions the encryption target data into a block group having predetermined data units, and then outputs encrypted data for the block group by using the key information to encrypt the encryption target data in order starting from the leading block of the block group.

4. A cryptographic processing apparatus that decrypts encrypted data from another cryptographic processing apparatus using a fixed-value common key that is shared with other cryptographic processing apparatus, comprising:
a decrypting unit that outputs decrypted data by decrypting a decryption target data using decryption key information when the decryption target data and the decryption key information is set;
a determining unit that determines whether the format of the decrypted data is the format of random information being used within the cryptographic processing apparatus and the other cryptographic processing apparatus; and
a setting unit that executes a first decryption setting process comprising setting the fixed-value common key as the decryption key information and the encrypted data as the decryption target data, thereby causing the decrypting unit to output the random information, as the decrypted data, being used within the other cryptographic processing apparatus when the encrypted data is provided to the decrypting unit before the determination by the determining unit, and
executes a second decryption setting process comprising setting the encrypted data as the decryption target data when it is determined by the determining unit that the format of the decrypted data is the format of the random information being used within the cryptographic processing apparatus and the other cryptographic processing apparatus.

5. The cryptographic processing apparatus according to claim 4, wherein
the setting unit executes a discard setting process instead of the second decryption setting process, wherein the decrypting unit is made to discard the encrypted data when it is determined by the determining unit that the format of the decrypted data is not the format of the random information being used within the cryptographic processing apparatus and the other cryptographic processing apparatus.

6. The cryptographic processing apparatus according to claim 4, wherein
the random information is time information being used within the other cryptographic processing apparatus.

7. The cryptographic processing apparatus according to claim 6, wherein
the setting unit executes the second decryption setting process when the time information being used within the other cryptographic processing apparatus is compared to time information being used within the cryptographic processing apparatus and being within a predetermined range.

8. The cryptographic processing apparatus according to claim 4, wherein
when a block group having predetermined data units is set as the decryption target data, the decrypting unit outputs decrypted data by using the decryption information to decrypt the decryption target data in order starting from the leading block of the block group, and
the determining unit determines whether the format of the decrypted data for the leading block is the format of random information being used within the cryptographic processing apparatus and the other cryptographic processing apparatus.

9. A cryptographic processing method implemented in a cryptographic processing apparatus, which encrypts plaintext using a fixed-value common key that is shared with other cryptographic processing apparatus, the method comprising:
acquiring random information being used within the cryptographic processing apparatuses;
encrypting the encryption target data using key information when encryption target data and key information is set;
outputting encrypted data of the encryption target data;
transmitting, to the other cryptographic processing apparatus, the encrypted encryption target data; and
setting the fixed-value common key as the key information and the random information as the encryption target data when the random information is acquired by the acquiring unit, and setting at least one portion of the plaintext as the target data when the encrypted data is acquired.

10. The cryptographic processing method according to claim 9, wherein
in the encrypting, the encryption target data is first partitioned into a block group having predetermined data units, and then encrypted target data for the block group is encrypted by using the key information to encrypt the encryption target data in order starting from the leading block of the block group.

11. A cryptographic processing method implemented in a cryptographic processing apparatus, which decrypts encrypted data transmitted from another cryptographic processing apparatus using a fixed-value common key, the method comprising:
decrypting decryption target data using decryption key information when the decryption target data and the decryption key information are set;
determining whether the format of the decrypted decryption target data is the format of random information being used within the cryptographic processing apparatus and the other cryptographic processing apparatus; and
setting the fixed-value common key as the decryption key information, and setting the encrypted data as the decryption target data, thereby outputting the random information being used within the other cryptographic processing apparatus as the decrypted data when the encrypted data is provided before the determination in the determining, and setting the encrypted data as the decryption target data when it is determined in the determining that the format of the decrypted data is the format of the random information being used within the cryptographic processing apparatus and the other cryptographic processing apparatus.

12. The cryptographic processing method according to claim 11, wherein
when a block group having predetermined data units is set as the decryption target data, the decryption key information is used to decrypt the decryption target data in order starting from the leading block of the block group, and
in the determining, it is determined whether the format of the decrypted data for the leading block is the format of random information being used within the cryptographic processing apparatus and the other cryptographic processing apparatus.
